(19) United States
(12) Patent Application Publication
(10) Pub. No.: US 2021/0377176 A1
(43) Pub. Date: Dec. 2, 2021

(54) TRAFFIC CLASS-BASED ESP SEQUENCE

(71) Applicant: Apple Inc., Cupertino, CA (US)

(72) Inventors: Sushant U. Chavan, San Jose, CA (US); Delziel J. Fernandes, San Jose, CA (US); Thomas F. Pauly, Campbell, CA (US)

(21) Appl. No.: 17/007,326

(22) Filed: Aug. 31, 2020

Related U.S. Application Data
(60) Provisional application No. 63/033,638, filed on Jun. 2, 2020.

(51) Int. Cl. H04L 12/859; H04L 12/851; H04L 12/865; H04L 29/06

(52) U.S. Cl. CPC H04L 47/2475; H04L 47/2483; H04L 63/0485; H04L 69/22; H04L 47/6275

(57) ABSTRACT

An electronic device includes a sequence generator module that generates a sequence in a predetermined order based on a traffic class of data to be sent. The sequence is written into a portion of a sequence header of an outgoing data packet that corresponds to the traffic class. A traffic class identifier is also written into a header of the packet that indicates the traffic class of the data. The electronic device sends the packet to another electronic device over one of multiple channels of multiple priorities. The other electronic device determines the traffic class of the data based on the traffic class identifier, extracts the sequence from the portion of the sequence header that corresponds to the traffic class, and compares the sequence to a previously extracted sequence of a previously received packet of the same traffic class to determine whether a replay attack has occurred.

### CROSS-REFERENCE TO RELATED APPLICATION

This application claims the benefit of U.S. Provisional Application No. 63/033,638, filed Jun. 2, 2020, which is hereby incorporated by reference in its entirety for all purposes.

### BACKGROUND

The present disclosure relates generally to computer networks, and more particularly to securely sending and receiving information over a computer network.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Computing devices may establish connections between one another to send and receive data. In some cases, a third party may seek access to one of the computing devices by re-sending at least a portion of the data sent and received between the computing devices to fraudulently authenticate the third party (e.g., performing a replay or playback attack). To prevent such an attack, some network protocols may embed a sequence in packets sent between the computing devices that follows a certain order. If a packet is received that has a sequence that does not follow the certain order, then it may be determined that a replay attack has occurred, and the packet may be rejected.

However, some connections enable data to be sent over multiple communication channels of multiple priorities (e.g., at approximately the same time). As such, data packets distributed and sent over the multiple channels may be received in a different order than which the data packets were sent, which may result in a determination that a replay attack has occurred, causing certain data packets to be rejected.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

An electronic device may include a sequence generator module that generates a sequence in a predetermined order based on a traffic class of data to be sent. For example, outgoing data packets from the electronic device may be grouped into voice traffic, video traffic, best effort traffic, and background traffic. Each packet may include a sequence header that is used to prevent replay attacks by checking to see if the sequence header is in the predetermined order (e.g., as compared to a sequence header of a previously received packet). In particular, the sequence header may be divided into respective portions corresponding to the traffic classes. That is, the sequence header may include a first portion corresponding to voice traffic, a second portion corresponding to video traffic, a third portion corresponding to best effort traffic, and a fourth portion corresponding to background traffic.

A processor of the electronic device may embed the generated sequence for data into the portion of the sequence header that corresponds to the traffic class of the data. The processor may also embed a traffic class identifier into a header of the packet that indicates the traffic class of the data. Upon reception of the packet, another electronic device may determine the traffic class of the data based on the traffic class identifier, and extract the sequence from the portion of the sequence header that corresponds to the traffic class.

Thus, even if data packets are received in a different order than they were sent (e.g., due to being sent over different communication channels of multiple priorities), packets for each traffic class may nevertheless be received in the order that they were sent. As such, the sequences for each traffic class may remain in the proper order, thus preventing mistaken determinations that a replay attack has occurred, and ultimately preventing unnecessary rejections of data packets.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings in which:

FIG. 1 is a schematic block diagram of an electronic device including a transceiver, in accordance with an embodiment;

FIG. 2 is a perspective view of a notebook computer representing a first embodiment of the electronic device of FIG. 1;

FIG. 3 is a front view of a handheld device representing a second embodiment of the electronic device of FIG. 1;

FIG. 4 is a front view of another handheld device representing a third embodiment of the electronic device of FIG. 1;

FIG. 5 is a front view of a desktop computer representing a fourth embodiment of the electronic device of FIG. 1;

FIG. 6 is a front view and side view of a wearable electronic device representing a fifth embodiment of the electronic device of FIG. 1;

FIG. 7 is a diagram showing the electronic device of FIG. 1 communicating with another electronic device and corresponding Open Systems Interconnection model layers, according to embodiments of the present disclosure;

FIG. 8 is a block diagram illustrating sequences generated by a sequence generator module of the electronic device of FIG. 1, according to embodiments of the present disclosure;

FIG. 9 is a schematic diagram illustrating the electronic device of FIG. 1 sending data of different traffic classes over multiple communication channels of multiple priorities to the other electronic device, according to embodiments of the present disclosure;

FIG. 10 is a diagram of a portion of a packet, including a sequence generated by the sequence generator module of the electronic device FIG. 1, according to embodiments of the present disclosure;

FIG. 11 is a flowchart of a method for sending a packet with a traffic class-based sequence, according to embodiments of the present disclosure; and

FIG. 12 is a flowchart of a method for receiving a packet with a traffic class-based sequence, according to embodiments of the present disclosure.

### DETAILED DESCRIPTION

One or more specific embodiments of the present disclosure will be described below. These described embodiments are examples of the presently disclosed techniques. Additionally, in an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time-consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment”, “an embodiment”, or “in some embodiments” of the present disclosure are not intended to be interpreted as excluding the existence of additional embodiments that also incorporate the recited features.

The disclosed embodiments may apply to a variety of electronic devices. In particular, any electronic device that transmits or receives signals over a communication network may incorporate the disclosed sequence generator module or techniques to ensure that sequences for each traffic class of data may remain in a proper order. With the foregoing in mind, a general description of suitable electronic devices that may include the disclosed sequence generator module or techniques is provided below.

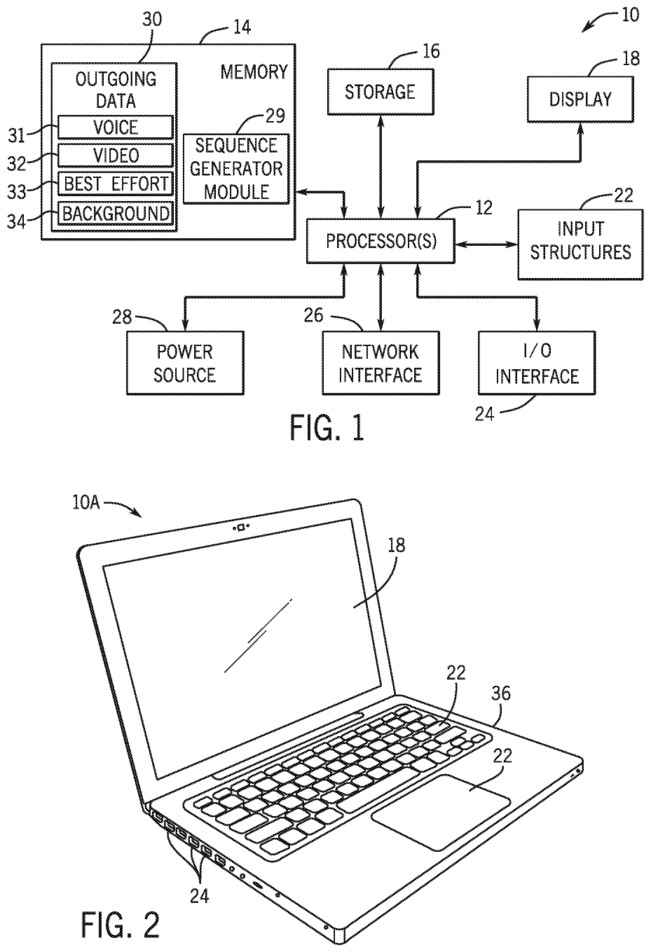

Turning first to FIG. 1, an electronic device 10 according to an embodiment of the present disclosure may include, among other things, one or more of processors 12, memory 14, nonvolatile storage 16, a display 18, input structures 22, an input/output (I/O) interface 24, a network interface 26, and a power source 28. The various functional blocks shown in FIG. 1 may include hardware elements (including circuitry), software elements (including computer code stored on a computer-readable medium) or a combination of both hardware and software elements. Furthermore, a combination of elements may be included in tangible, non-transitory, and machine-readable medium that include machine-readable instructions. The instructions may be executed by the processor 12 and may cause the processor 12 to perform operations as described herein. It should be noted that FIG. 1 is merely one example of a particular embodiment and is intended to illustrate the types of elements that may be present in the electronic device 10. Additionally, reference to the processor 12 in the present disclosure should be understood to include any processor or combination of processors of the one or more of processors 12.

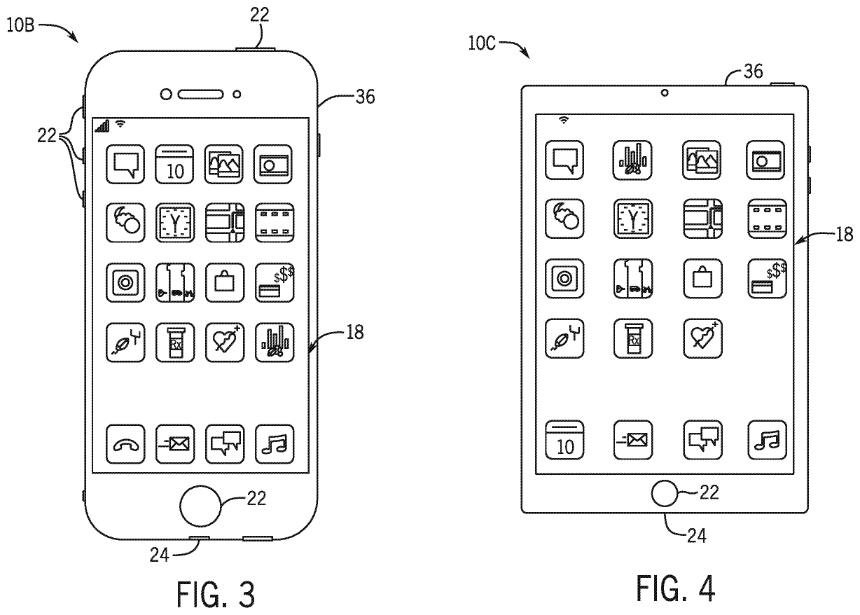

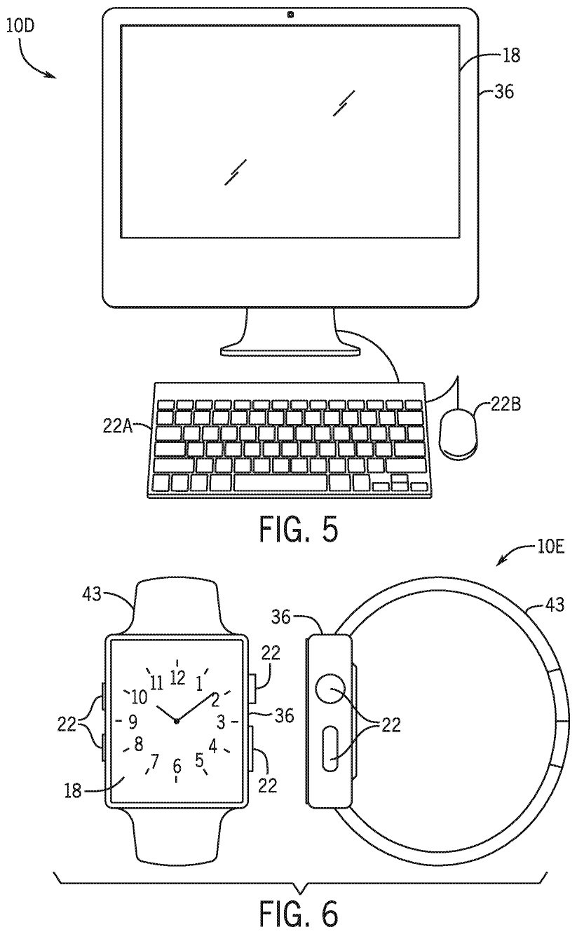

By way of example, a block diagram of the electronic device 10 may represent the notebook computer depicted in FIG. 2, the handheld device depicted in FIG. 3, the handheld device depicted in FIG. 4, the desktop computer depicted in FIG. 5, the wearable electronic device depicted in FIG. 6, or similar devices. It should be noted that the processor 12 and other related items in FIG. 1 may be generally referred to herein as “data processing circuitry.” Such data processing circuitry may be embodied wholly or in part as software, firmware, hardware, or any combination thereof. Furthermore, the data processing circuitry may be a single contained processing module or may be incorporated wholly or partially within any of the other elements within the electronic device 10.

In the electronic device 10 of FIG. 1, the processor 12 may operably couple with the memory 14 and the nonvolatile storage 16 to perform various algorithms. Such programs or instructions executed by the processor 12 may be stored in any suitable article of manufacture that includes one or more tangible, computer-readable media at least collectively storing the instructions or processes, such as the memory 14 and the nonvolatile storage 16. The memory 14 and the nonvolatile storage 16 may include any suitable articles of manufacture for storing data and executable instructions, such as random-access memory, read-only memory, rewritable flash memory, hard drives, and optical discs. Also, programs (e.g., an operating system) encoded on such a computer program product may also include instructions executable by the processor 12 to enable the electronic device 10 to provide various functionalities.

As illustrated, the memory 14 may store a sequence generator module 29 as instructions executable by the processor 12. The sequence generator module 29 may generate a sequence in a predetermined order based on a traffic class of data to be sent. As illustrated, the memory 14 may also store outgoing data 30 from the electronic device 10, including voice traffic 31, video traffic 32, best effort traffic 33, and background traffic 34. The outgoing data 30 may be formed into packets (e.g., Internet Protocol (IP) packets) that may include a sequence header (e.g., an Encapsulating Security Payload (ESP) header) that is used to prevent replay attacks by checking to see if the sequence header is in the predetermined order (e.g., as compared to a sequence header of a previously received packet). The sequence header may be divided into respective portions corresponding to the traffic classes, and the processor 12 may embed the generated sequence in the portion of the sequence header that corresponds to the traffic class of the payload of the packet. While the sequence generator module 29 and the outgoing data 30 are illustrated as being stored in the memory 14, it should be understood that these elements may be stored in any suitable medium or component, such as the storage 16 and/or the network interface 26. Moreover, while the sequence generator module 29 is described as software, it should be understood that sequence generator module 29 may be implemented, in whole or in part, as firmware (e.g., stored on the memory 14 or storage 16) and/or hardware (e.g., as part of the processor 12 and/or the network interface 26) of the electronic device 10.

In certain embodiments, the display 18 may be a liquid crystal display (LCD), which may facilitate users to view images generated on the electronic device 10. In some embodiments, the display 18 may include a touch screen, which may facilitate user interaction with a user interface of the electronic device 10. Furthermore, it should be appreciated that, in some embodiments, the display 18 may include one or more organic light emitting diode (OLED) displays, or some combination of LCD panels and OLED panels.

The input structures 22 of the electronic device 10 may enable a user to interact with the electronic device 10 (e.g., pressing a button to increase or decrease a volume level). The I/O interface 24 may enable the electronic device 10 to interface with various other electronic devices, as may the network interface 26.

The network interface 26 may include, for example, one or more interfaces for a personal area network (PAN), such as a BLUETOOTH® network, for a local area network (LAN) or wireless local area network (WLAN), such as an 802.11x WI-FI® network, and/or for a wide area network (WAN), such as a 3^{rd} generation (3G) cellular network, 4^{th} generation (4G) cellular network, long term evolution (LTE®) cellular network, long term evolution license assisted access (LTE-LAA) cellular network, 5^{th} generation (5G) cellular network, or New Radio (NR) cellular network. The network interface 26 may also include one or more interfaces for, for example, broadband fixed wireless access networks (e.g., WIMAX®), mobile broadband Wireless networks (mobile WIMAX®), asynchronous digital subscriber lines (e.g., ADSL, VDSL), digital video broadcasting-terrestrial (DVB-T®) network and its extension DVB Handheld (DVB-H®) network, ultra-wideband (UWB) network, alternating current (AC) power lines, and so forth. The network interface 26 may be implemented as software (e.g., as a logical construct) and/or hardware (e.g., as a network interface controller, card, or adapter). For example, the network interface 26 may include an Internet Protocol Security (IPSec) interface that enables use of the IPSec secure network protocol suite to authenticate and encrypt packets of data to provide secure encrypted communication between the two electronic devices over an Internet Protocol (IP) network.

As further illustrated, the electronic device 10 may include the power source 28. The power source 28 may include any suitable source of power, such as a rechargeable lithium polymer (Li-poly) battery and/or an alternating current (AC) power converter.

In certain embodiments, the electronic device 10 may take the form of a computer, a portable electronic device, a wearable electronic device, or other type of electronic device. Such computers may be generally portable (such as laptop, notebook, and tablet computers) and/or those that are generally used in one place (such as conventional desktop computers, workstations and/or servers). In certain embodiments, the electronic device 10 in the form of a computer may be a model of a MacBook®, MacBook® Pro, MacBook Air®, iMac®, Mac® mini, or Mac Pro® available from Apple Inc. of Cupertino, Calif. By way of example, the electronic device 10, taking the form of a notebook computer 10A, is illustrated in FIG. 2 in accordance with one embodiment of the present disclosure. The notebook computer 10A may include a housing or the enclosure 36, the display 18, the input structures 22, and ports associated with the I/O interface 24. In one embodiment, the input structures 22 (such as a keyboard and/or touchpad) may enable interaction with the notebook computer 10A, such as starting, controlling, or operating a graphical user interface (GUI) and/or applications running on the notebook computer 10A. For example, a keyboard and/or touchpad may facilitate user interaction with a user interface, GUI, and/or application interface displayed on display 18.

FIG. 3 depicts a front view of a handheld device 10B, which represents one embodiment of the electronic device 10. The handheld device 10B may represent, for example, a portable phone, a media player, a personal data organizer, a handheld game platform, or any combination of such devices. By way of example, the handheld device 10B may be a model of an iPod® or iPhone® available from Apple Inc. of Cupertino, Calif. The handheld device 10B may include the enclosure 36 to protect interior elements from physical damage and to shield them from electromagnetic interference. The enclosure 36 may surround the display 18. The I/O interface 24 may open through the enclosure 36 and may include, for example, an I/O port for a hard wired connection for charging and/or content manipulation using a standard connector and protocol, such as the Lightning connector provided by Apple Inc. of Cupertino, Calif., a universal serial bus (USB), or other similar connector and protocol.

The input structures 22, in combination with the display 18, may enable user control of the handheld device 10B. For example, the input structures 22 may activate or deactivate the handheld device 10B, navigate a user interface to a home screen, present a user-editable application screen, and/or activate a voice-recognition feature of the handheld device 10B. Other of the input structures 22 may provide volume control, or may toggle between vibrate and ring modes. The input structures 22 may also include a microphone to obtain a user's voice for various voice-related features, and a speaker to enable audio playback. The input structures 22 may also include a headphone input to enable input from external speakers and/or headphones.

FIG. 4 depicts a front view of another handheld device 10C, which represents another embodiment of the electronic device 10. The handheld device 10C may represent, for example, a tablet computer, or one of various portable computing devices. By way of example, the handheld device 10C may be a tablet-sized embodiment of the electronic device 10, which may be, for example, a model of an iPad® available from Apple Inc. of Cupertino, Calif.

Turning to FIG. 5, a computer 10D may represent another embodiment of the electronic device 10 of FIG. 1. The computer 10D may be any computer, such as a desktop computer, a server, or a notebook computer, but may also be a standalone media player or video gaming machine. By way of example, the computer 10D may be an iMac®, a MacBook®, or other similar device by Apple Inc. of Cupertino, Calif. It should be noted that the computer 10D may also represent a personal computer (PC) by another manufacturer. The enclosure 36 may protect and enclose internal elements of the computer 10D, such as the display 18. In certain embodiments, a user of the computer 10D may interact with the computer 10D using various peripheral input devices, such as keyboard 22A or mouse 22B (e.g., input structures 22), which may operatively couple to the computer 10D.

Similarly, FIG. 6 depicts a wearable electronic device 10E representing another embodiment of the electronic device 10 of FIG. 1. By way of example, the wearable electronic device 10E, which may include a wristband 43, may be an Apple Watch® by Apple Inc. of Cupertino, California. However, in other embodiments, the wearable electronic device 10E may include any wearable electronic device such as, a wearable exercise monitoring device (e.g., pedometer, accelerometer, heart rate monitor), or other device by another manufacturer. The display 18 of the wearable electronic device 10E may include a touch screen version of the display 18 (e.g., LCD, OLED display, active-matrix organic light emitting diode (AMOLED) display, and so forth), as well as the input structures 22, which may facilitate user interaction with a user interface of the wearable electronic device 10E.

In certain embodiments, as previously noted above, each embodiment (e.g., notebook computer 10A, handheld device 10B, handheld device 10C, computer 10D, and wearable electronic device 10E) of the electronic device 10 may include the disclosed sequence generator module 29 or techniques to ensure that sequences for each traffic class of data may remain in a proper order.

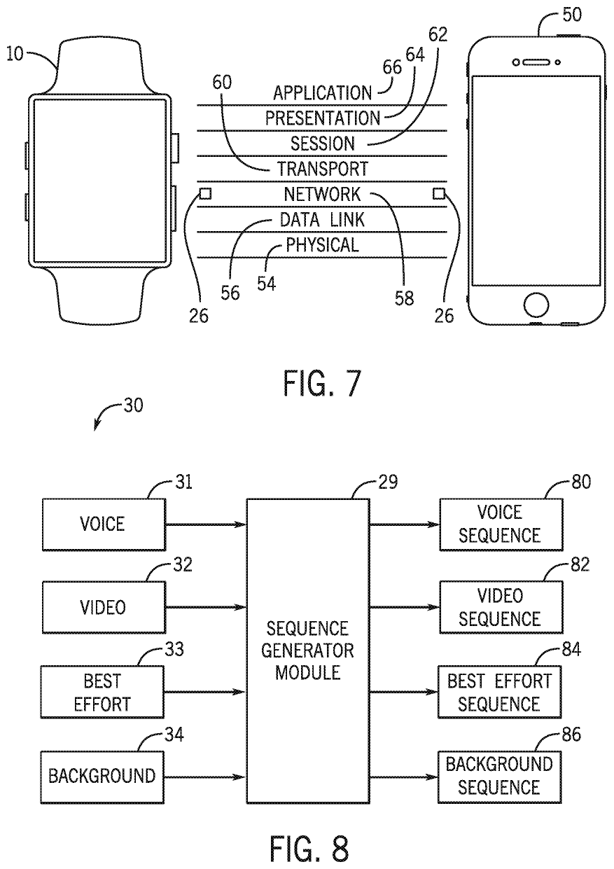

With the foregoing in mind, FIG. 7 is a diagram showing the electronic device 10 communicating with another electronic device 50 and the corresponding Open Systems Interconnection (OSI) model layers, according to embodiments of the present disclosure. As illustrated, the electronic device 10 may communicate with the other electronic device 50 via respective network interfaces 26, 52. The OSI model layers include a physical layer 54, a data link layer 56, a network layer 58, a transport layer 60, a session layer 62, a presentation layer 64, and an application layer 66. In particular, because the disclosed sequence generator module 29 and techniques generate, modify, embed information in and/or extract information from an address of a network protocol, such as IP version 6 (IPv6)), the disclosed sequence generator module 29 and techniques relate to the network layer 58.

FIG. 8 is a block diagram illustrating sequences generated by the sequence generator module 29 of the electronic device 10, according to embodiments of the present disclosure. The sequence generator module 29 may generate sequences based on a variety of types of outgoing data 30. As illustrated, the sequence generator module 29 may generate sequences based on voice traffic 31, video traffic 32, best effort traffic 33, and background traffic 34. The voice traffic 31 may include incoming and outgoing voice communication. The video traffic 32 may include video streaming. The best effort traffic 33 may include traffic from legacy devices or traffic from applications or devices that do not support Quality of Service (QoS). The background traffic 34 may include file downloads and print jobs.

The sequence generator module 29 may generate a respective sequence for each traffic class. For some network security protocols, such as IPSec, a sequence (e.g., an Encapsulating Security Payload (ESP) sequence) may be embedded in packets (e.g., IP packets) sent between the electronic device 10 and another electronic device (e.g., 50) that follows a certain order. The sequence may be monotonically increased in each IP packet that is sent. If a packet is received that has a sequence that does not follow the certain order, then it may be determined that a replay attack has occurred, and the packet may be rejected. However, some connections (e.g., Bluetooth connections) enable data to be sent over multiple communication channels of multiple priorities (e.g., at approximately the same time). As such, data packets distributed and sent over the multiple channels may be received by the other electronic device 50 in a different order than which the data packets were sent, thus causing the other electronic device 50 to receive packets with sequences that are out of order. As a result, the other electronic device 50 may determine that a replay attack is occurring and reject the data packets.

The sequence generator module 29 may instead store a current sequence for each traffic class, and monotonically increase a respective sequence for a traffic class as a respective current sequence for the traffic class is written into a sequence header of the packet. That is, in the example of four different traffic classes (e.g., the voice traffic class 31, the video traffic class 32, the best effort traffic class 33, and the background traffic class 34), the sequence generator module 29 may store a current voice sequence 80, a current video sequence 82, a current best effort sequence 84, and a current background sequence 86. As, for example, video traffic 32 is packetized to be send to the other electronic device 50, the sequence generator module 29 may write the current video sequence 82 in the sequence header of the corresponding data packet, and then monotonically increase the video sequence 82 (for use in the next video traffic data packet). The sequence generator module 29 may not write or monotonically increase the current voice sequence 80, the current best effort sequence 84, or the current background sequence 86, as the sequences 80, 84, 86 do not correspond to the video traffic 32 being sent to the other electronic device 50.

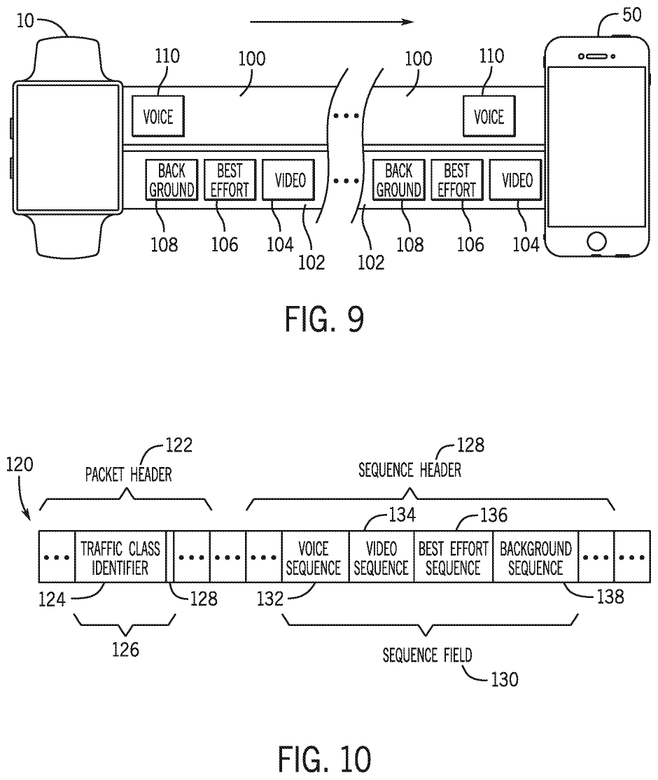

FIG. 9 is a schematic diagram illustrating the electronic device 10 sending data of different traffic classes over multiple communication channels of multiple priorities to the other electronic device 50, according to embodiments of the present disclosure. As illustrated, the electronic device 10 may be a wearable electronic device (e.g., 10E) and the other electronic device 50 may be a handheld device (e.g., 10B), though it should be understood that the disclosed techniques may apply to any suitable electronic devices (e.g., two handheld devices, a wearable electronic device and a computer (e.g., 10D), two wearable electronic devices, and so on).

As mentioned above, certain connections, such as Bluetooth connections, enable multiple communication channels of multiple priorities between two communication endpoints. In particular, the electronic device 10 may be connected to the other electronic device 50 over a higher priority channel 100, and a lower priority channel 102 (though the disclosed techniques may apply similarly to connection types enabling more channels of different priorities). In particular, the higher priority channel 100 may enable data to travel faster than the lower priority channel 102.

As an illustrative example, the electronic device 10 may send a video traffic packet 104, a best effort traffic packet 106, a background traffic packet 108, and a voice traffic packet 110 to the other electronic device 50. The electronic device 10 may first send the video traffic packet 104, the best effort packet 106, and then the background traffic packet 108 on the lower priority channel 102. After sending the background traffic packet 108 on the lower priority channel 102, the electronic device 10 may send the voice traffic packet 110 on the higher priority channel 100.

The other electronic device 50 may receive the video traffic packet 104 first on the lower priority channel 102 first, then receive the voice traffic packet 110 on the higher priority channel 100, followed by the best effort traffic packet 106 and the background traffic packet 108 on the lower priority channel 102. As such, despite the voice traffic packet 110 being sent after the video, best effort, and background traffic packets 104, 106, 108, it may be received after the video traffic packet 104 but before the best effort and background traffic packets 106, 108. That is, because packets of different classes may be distributed and sent on multiple communication channels of multiple priorities, the packets may be received in a different order than they were sent.

If the electronic device 10 applied a global monotonically increasing sequence for all packets in a sequence header of the packets, then the best effort and background traffic packets 106, 108 may be flagged as possible replay attacks and be rejected by the other electronic device 50 due to being received out of order. That is, the electronic device 10 would assign a lowest sequence to the video traffic packet 104 (e.g., 0), a second lowest sequence to the best effort traffic packet 106 (e.g., 1), a third lowest sequence to the background traffic packet 108 (e.g., 2), and a highest sequence to the voice traffic packet 110 (e.g., 3). However, when the other electronic device 50 extracts the sequences, it may first receive the lowest sequence of the video traffic packet 104 (e.g., 0), then the highest sequence of the voice traffic packet 110 (e.g., 3), and finally the second and third lowest sequences of the best effort and background traffic packets 106, 108 (e.g., 1 and 2). Because the second and third lowest sequences of the best effort and background traffic packets 106, 108 are not greater than the highest sequence of the voice traffic packet 110, the other electronic device 50 may determine that these are indicative of replay attacks and reject the data packets.

Instead, because the sequence generator module 29 generates a different sequence for each traffic class, the other electronic device 50 may compare each sequence of the data packets only to sequences of previously received packets of the same traffic class, preventing mistaken rejections of data packets. FIG. 10 is a diagram of a portion of a packet 120, including a sequence generated by the sequence generator module 29 of the electronic device 10, according to embodiments of the present disclosure. As mentioned above, the packet 120 may be an IPv6 packet, and thus may have a minimum maximum transmission unit (MTU) of 1280 octets. The packet 120 may include a packet header 122 that may include a traffic class identifier 124 that indicates the traffic class (e.g., voice traffic 31, video traffic 32, best effort traffic 33, background traffic 34) of the packet. For IPv6, the packet header 122 may have a size of 40 octets (320 bits), and a traffic class field 126 that includes the traffic class identifier 124 (which may be six bits in size and referred to as a Differentiated Services field) and a two bit Explicit Congestion Notification field. The packet header 122 may include other fields, for example, related to payload length, next header, hop limit, source address, destination address, and so on.

The packet 120 may also include a sequence header 128. For an IPSec packet, the sequence header 128 may be referred to as an Encapsulating Security Payload (ESP) header, and may include a 4 octet (32 bit) sequence field 130, among other fields. The sequence field 130 may be divided among the traffic classes. That is, there may be an 8 bit voice sequence field 132, an 8 bit video sequence field 134, an 8 bit best effort sequence field 136, and an 8 bit background sequence field 138. For data of a particular traffic class, the sequence generated by the sequence generator module 29 corresponding to the particular traffic class may be written to the corresponding 8 bit sequence field.

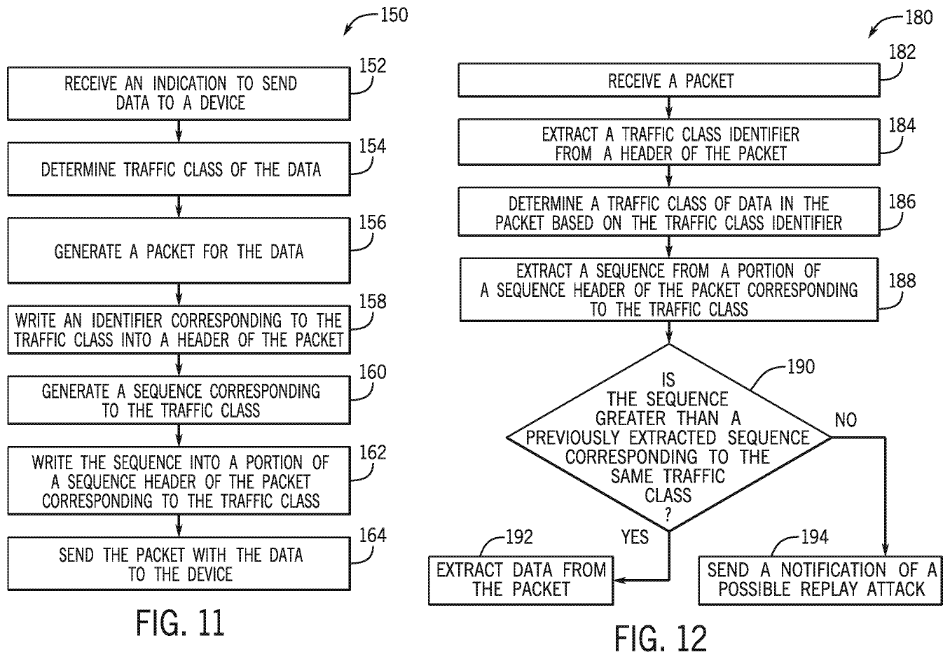

With the foregoing in mind, FIG. 11 is a flowchart of a method 150 for sending a packet 120 with a traffic class-based sequence, according to embodiments of the present disclosure. Any suitable device (e.g., a controller) that may control components of the electronic device 10, such as the processor 12, may perform the method 150. In some embodiments, the method 150 may be implemented by executing instructions stored in a tangible, non-transitory, computer-readable medium, such as the memory 14 or storage 16, using the processor 12. For example, the method 150 may be performed at least in part by one or more software components, such as an operating system of the electronic device 10, the sequence generator module 29 (as described below), and the like. While the method 150 is described using steps in a specific sequence, it should be understood that the present disclosure contemplates that the described steps may be performed in different sequences than the sequence illustrated, and certain described steps may be skipped or not performed altogether.

In process block 152, the processor 12 receives an indication to send data to a device (e.g., the other electronic device 50). In process block 154, the processor 12 and/or the sequence generator module 29 determines the traffic class of the data. As mentioned above, the traffic class may include, but not be limited to, voice traffic 31, video traffic 32, best effort traffic 33, and/or background traffic 34. In process block 156, the processor 12 generates a packet 120 for the data. In some embodiments, the packet 120 may be an IP packet, such as an IP version 4 (IPv4), IPv6, and/or an IPSec packet.

In process block 158, the processor 12 and/or the sequence generator module 29 writes an identifier 124 corresponding to the traffic class into a header of the packet 120. The identifier 124 may indicate the traffic class. For an IPSec packet, the identifier 124 may be written in the Differentiated Services field portion of the traffic class field 126 of the packet header 122.

In process block 160, the sequence generator module 29 generates a sequence corresponding to the traffic class. In particular, the sequence generator module 29 may store a current sequence for each traffic class (e.g., the current voice sequence 80, the current video sequence 82, the current best effort sequence 84, and the current background sequence 86) that, for IPSec, was monotonically increased from an immediately previous sequence for each traffic class, which may be used as the sequence. The sequence generator module 29 may then monotonically increase the current sequence for the traffic class for use with next data of the traffic class. In additional or alternative embodiments, the sequence generator module 29 may first monotonically increase the stored current sequence for the traffic class, which then may be used as the sequence.

In process block 162, the sequence generator module 29 writes the sequence into a portion of a sequence header 128 of the packet 120 corresponding to the traffic class. For an IPSec packet, the sequence header 128 may be referred to as an ESP header. The sequence header 128 may be divided into portions corresponding to each traffic class (e.g., a voice sequence field 132, a video sequence field 134, a best effort sequence field 136, and a background sequence field 138). For example, if the data is of the best effort traffic class 33, then the sequence generator module 29 writes the sequence into the best effort sequence field 136.

In process block 164, the processor 12 sends the packet 120 with the data to the device. As mentioned above, the processor 12 may send the packet 120 over one of multiple channels of multiple priorities. Because the sequence generator module 29 generates a different sequence for each traffic class, the method 150 enables the other electronic device 50 to compare each sequence of the data packets only to sequences of previously received packets of the same traffic class, preventing mistaken rejections of data packets.

FIG. 12 is a flowchart of a method 180 for receiving a packet 120 with a traffic class-based sequence, according to embodiments of the present disclosure. Any suitable device (e.g., a controller) that may control components of the electronic device 10, such as the processor 12, may perform the method 180. In some embodiments, the method 180 may be implemented by executing instructions stored in a tangible, non-transitory, computer-readable medium, such as the memory 14 or storage 16, using the processor 12. For example, the method 180 may be performed at least in part by one or more software components, such as an operating system of the electronic device 10. While the method 180 is described using steps in a specific sequence, it should be understood that the present disclosure contemplates that the described steps may be performed in different sequences than the sequence illustrated, and certain described steps may be skipped or not performed altogether.

In process block 182, the processor 12 receives a packet 120. In process block 184, the processor 12 extracts a traffic class identifier 124 from a header 122 of the packet 120. For an IPSec packet, the traffic class identifier 124 may be extracted from the Differentiated Services field portion of the traffic class field 126 of the packet header 122. The identifier 124 may indicate the traffic class. As such, in process block 186, the processor 12 determines a traffic class of data in the packet 120 based on the traffic class identifier 124.

In process block 188, the processor 12 extracts a sequence from a portion of a sequence header 128 of the packet 120 corresponding to the traffic class. For an IPSec packet, the sequence header 128 may be referred to as an ESP header. The sequence header 128 may be divided into portions corresponding to each traffic class (e.g., a voice sequence field 132, a video sequence field 134, a best effort sequence field 136, and a background sequence field 138). For example, if the data is of the best effort traffic class 33, then the processor 12 extracts the sequence from the best effort sequence field 136.

In decision block 190, the processor 12 determines whether the sequence is greater than a previously extracted sequence corresponding to the same traffic class. In particular, the electronic device 10 may store the most recent extracted sequences for each traffic class. As such, the processor 12 may compare the sequence to the most recent extracted sequence for the same traffic class. For example, if the sequence is for a data packet of the background traffic class 34, then the processor 12 may compare the sequence to the extracted sequence of the immediately previously received data packet of the background traffic class 34. While decision block 190 determines whether the sequence is greater than the previously extracted sequence, it should be understood that any suitable comparison scheme is contemplated to determine whether a replay attach is occurring (e.g., determining whether the sequence is less than the previously extracted sequence, determining whether the sequence and one or more previously extracted sequences follow a predetermined pattern, and so on).

If the processor 12 determines that the sequence is greater than the previously extracted sequence corresponding to the same traffic class, then the sequence does not indicate a replay attack, and, in process block 192, the processor 12 extracts the data from the packet 120. On the other hand, if the processor 12 determines that the sequence is not greater than the previously extracted sequence corresponding to the same traffic class, then the sequence indicates a replay attack may be occurring, and, in process block 194, the processor 12 indicates that an error has occurred and/or sends a notification of the possible replay attack. Accordingly, the processor 12 may refrain from extracting data from the packet 120. The processor 12 may also reject the packet 120. As mentioned above, the processor 12 may receive the packet 120 over one of multiple channels of multiple priorities. Because the sequence generator module 29 generates a different sequence for each traffic class, the method 180 enables the electronic device 10 to compare each sequence of the data packets only to sequences of previously received packets of the same traffic class, preventing mistaken rejections of data packets and packet loss, thus improving the user experience.

Accordingly, the sequence generator module 29 may generate a first sequence of a first packet 120 of a first traffic class to be sent over a first channel before generating a second sequence of a second packet 120 of a second traffic class to be sent over a second channel, where the first sequence is greater than the second sequence. But because the first sequence is not compared to the second sequence due to the sequences corresponding to different traffic classes, an error may not be generated. Correspondingly, the first packet 120 may also be sent over the first channel before sending the second packet 120 over the second channel.

Similarly, the sequence generator module 29 may generate a first sequence of a first packet 120 of a first traffic class to be sent over a first channel after generating a second sequence of a second packet 120 of a second traffic class to be sent over a second channel, where the first sequence is less than the second sequence. But because the first sequence is not compared to the second sequence due to the sequences corresponding to different traffic classes, an error may not be generated. Correspondingly, the first packet 120 may also be sent over the first channel after sending the second packet 120 over the second channel.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

What is claimed is:

1. One or more tangible, non-transitory, computer-readable media, comprising computer-readable instructions that, when executed by one or more processors of a computer, cause the one or more processors to:
receive an indication to send data to an electronic device;
determine a traffic class of the data;
generate a packet for the data;
generate a sequence corresponding to the traffic class;
write the sequence into the packet; and
send the packet with the data to the electronic device.

2. The one or more tangible, non-transitory, computer-readable media of claim 1, wherein the traffic class is one of a plurality of traffic classes, the plurality of traffic classes comprising voice traffic, video traffic, best effort traffic, and background traffic.

3. The one or more tangible, non-transitory, computer-readable media of claim 2, wherein the computer-readable instructions cause the one or more processors to write an identifier corresponding to the traffic class into a sequence header of the packet.

4. The one or more tangible, non-transitory, computer-readable media of claim 3, wherein the sequence header comprises a sequence field comprising a plurality of portions, wherein each portion of the plurality of portions corresponds to a respective traffic class of the plurality of traffic classes.

5. The one or more tangible, non-transitory, computer-readable media of claim 4, wherein each portion of the plurality of portions is eight bits in size.

6. The one or more tangible, non-transitory, computer-readable media of claim 1, wherein the computer-readable instructions cause the one or more processors to generate the sequence by increasing a previous sequence corresponding to the traffic class.

7. The one or more tangible, non-transitory, computer-readable media of claim 1, wherein the computer-readable instructions cause the one or more processors to write an identifier corresponding to the traffic class into a packet header of the packet.

8. An electronic device comprising:
a network interface;
one or more storage devices configured to store a policy table;
one or more processors configured to:
receive an indication to send data to an additional electronic device;
determine a traffic class of the data;
generate a packet for the data;
generate a sequence corresponding to the traffic class;
write the sequence into the packet; and
send the packet with the data to the additional electronic device using the network interface.

9. The electronic device of claim 8, wherein the packet comprises an Internet Protocol Security packet.

10. The electronic device of claim 9, wherein the one or more processors are configured to write the sequence into an Encapsulating Security Payload header of the Internet Protocol Security packet.

11. The electronic device of claim 8, wherein the network interface is configured to communicatively couple the electronic device to the additional electronic device via a plurality of channels.

12. The electronic device of claim 11, wherein a first channel of the plurality of channels is a lower priority channel, and a second channel of the plurality of channels is a high priority channel.

13. The electronic device of claim 11, wherein the one or more processors are configured to:
receive an additional indication to send additional data to the additional electronic device;
determine an additional traffic class of the additional data;
generate an additional packet for the additional data;
generate an additional sequence corresponding to the additional traffic class;
write the additional sequence into the additional packet; and
send the additional packet with the additional data to the additional electronic device using the network interface.

14. The electronic device of claim 13, wherein the one or more processors are configured to:
send the packet with the data to the additional electronic device on a first channel of the plurality of channels; and
send the additional packet with the additional data to the additional electronic device on a second channel of the plurality of channels.

15. The electronic device of claim 14, wherein the sequence is generated after the additional sequence, and wherein the sequence is less than the additional sequence.

16. The electronic device of claim 14, wherein the packet is sent after the additional packet, and wherein the sequence is less than the additional sequence.

17. A computer-implemented method comprising:
receiving, via a computer, a packet comprising a sequence header storing a traffic class identifier;
extracting, via the computer, the traffic class identifier from the sequence header of the packet;
determining, via the computer, a traffic class of data in the packet based on the traffic class identifier;
extracting, via the computer, a sequence from the packet;
in response to determining that the sequence is greater than a previously extracted sequence corresponding to the traffic class, extracting, via the computer, the data from the packet; and
in response to determining that the sequence is not greater than a previously extracted sequence corresponding to the traffic class, refraining, via the computer, from extracting the data from the packet.

18. The method of claim 17, comprising, in response to determining that the sequence is not greater than the previously extracted sequence corresponding to the traffic class, indicating, via the computer, an error.

19. The method of claim 17, comprising:
receiving, via the computer, an additional packet comprising an additional sequence header storing the traffic class identifier;
extracting, via the computer, the traffic class identifier from the additional sequence header of the additional packet;
determining, via the computer, that additional data in the additional packet is of the traffic class based on the traffic class identifier;
extracting, via the computer, an additional sequence from the additional packet; and
in response to determining that the additional sequence is greater than the sequence corresponding to the traffic class, extracting, via the computer, the data from the packet.

20. The method of claim 17, comprising:
receiving, via the computer, an additional packet comprising an additional sequence header storing an additional traffic class identifier, wherein the additional packet is received after the packet;
extracting, via the computer, the additional traffic class identifier from the additional sequence header of the additional packet;
determining, via the computer, an additional traffic class of additional data in the additional packet based on the additional traffic class identifier;
extracting, via the computer, an additional sequence from the additional packet; and
in response to determining that the additional sequence is greater than a previously extracted sequence corresponding to the additional traffic class, extracting, via the computer, the data from the packet, wherein the additional sequence is less than sequence.
